(19) United States
(12) Patent Application Publication
(10) Pub. No.: US 2022/0197325 A1
(43) Pub. Date: Jun. 23, 2022

(54) OPERATION DEVICE

(71) Applicant: TOYO DENSO KABUSHIKI KAISHA, Tokyo (JP)

(72) Inventors: Kazuma ARASHINA, Saitama (JP); Yutaka OGAWA, Saitama (JP)

(73) Assignee: TOYO DENSO KABUSHIKI KAISHA, Tokyo (JP)

(21) Appl. No.: 17/552,605

(22) Filed: Dec. 16, 2021

(30) Foreign Application Priority Data
Dec. 23, 2020 (JP) 2020-214149

(51) Int. Cl. G05G 1/08; G05G 9/047; G05G 1/02

(52) U.S. Cl. CPC G05G 1/08; G05G 1/025; G05G 9/047

(57) ABSTRACT

An operation device according to the present invention includes: a rotation operation unit that is rotatable about a rotation axis and is installed so that an operation site formed on a rotation surface is exposed outside through an opening formed in an operation panel; and a support unit that covers at least part of a separated site of the rotation operation unit located away from the operation site along a rotation axis direction and has a sliding site coming into contact with part of the separated site and slidably supporting rotation of the rotation operation unit. Then, the support unit is configured to form a space part retaining grease applied to the rotation operation unit between the support unit and the separated site located on a side opposite to the operation site of the rotation operation unit with reference to the sliding site.

### INCORPORATION BY REFERENCE

This application is based upon and claims the benefit of priority from Japanese patent application No. 2020-214149, filed on Dec. 23, 2020, the disclosure of which is incorporated herein in its entirety by reference.

### TECHNICAL FIELD

The present invention relates to an operation device that performs a rotation operation.

### BACKGROUND ART

As an operation device that operates various devices, a rotation-operation-type operation device that rotates an operation unit and operate is known. For example, Patent Document 1 describes a rotation-operation-type operation device installed in a mobile phone. To be specific, the operation device described in Patent Document 1 is configured so that the side face of a columnar rotating body serves as a rotation surface, the rotation surface is exposed to the outside through an opening formed in an operation panel, and the rotation surface is rotationally operated by an operator.
Patent Document 1: Japanese Unexamined Patent Application Publication No. JP-A 2009-199405

In the case of the rotation-operation-type operation device as described in Patent Document 1, through the opening of the operation panel, an adjacent portion of the rotation surface of the rotating body located inside the operation panel is visually recognized from outside. Then, grease used for smoothly rotating the rotating body may adhere to the adjacent portion of the rotation surface visually recognized through the opening, which causes a problem that the exposed grease impairs the design of the operation device. Particularly in the case of a configuration to make the adjacent portion of the rotation surface of the rotating body emit light, the adhesion of the grease to a light-emitting surface decreases the brightness and impairs the design. Such a problem may occur not only in an operation device mounted on a mobile phone but also in a rotation-operation-type operation device mounted on any device.

Accordingly, an object of the present invention is to solve the abovementioned problem that the design of a rotation-operation-type operation device is impaired.

### SUMMARY OF THE INVENTION

An operation device according to an aspect of the present invention includes: a rotation operation unit that is rotatable about a rotation axis and is installed so that an operation site formed on a rotation surface is exposed outside through an opening formed in an operation panel; and a support unit that covers at least part of a separated site of the rotation operation unit located away from the operation site along a rotation axis direction and has a sliding site coming into contact with part of the separated site and slidably supporting rotation of the rotation operation unit. The support unit is configured to form a space part retaining grease applied to the rotation operation unit, the space part being formed between the support unit and the separated site located on a side opposite to the operation site of the rotation operation unit with reference to the sliding site.

With the configuration as described above, the present invention can solve the problem that the design of a rotation-operation-type operation device is impaired.

### BRIEF DESCRIPTION OF DRAWINGS

FIG. 1 is a view showing the appearance of an operation device according to a first example embodiment of the present invention;

FIG. 2 is a view showing the outline of a configuration when an operation panel of the operation device disclosed in FIG. 1 is removed;

FIG. 3 is a cross-sectional view showing the outline of the configuration when the operation device disclosed in FIG. 1 is viewed from the side;

FIG. 4 is an enlarged cross-sectional view showing the outline of a configuration of part of the operation device disclosed in FIG. 3;

FIG. 5 is an enlarged cross-sectional view showing the outline of a configuration of part of the operation device disclosed in FIG. 3; and

FIG. 6 is a view simply showing another configuration example of the operation device disclosed in FIG. 1.

### EXAMPLE EMBODIMENT

### First Example Embodiment

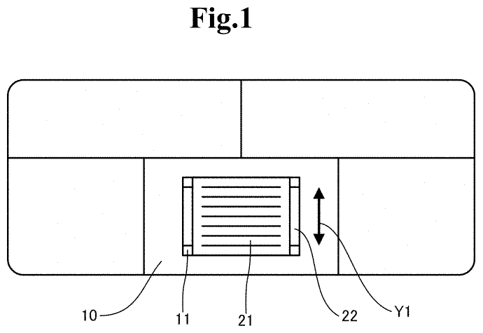

A first example embodiment of the present invention will be described with reference to FIGS. 1 to 6. FIGS. 1 to 6 are views for describing a configuration of an operation device.

The operation device according to the present invention is mounted on the steering of an automobile and is arranged on an operation panel 10 provided in a position on either the left side or the right side with reference to the center of the steering, for example. An example of the operation panel 10 is shown in FIG. 1. A plurality of operation devices (switches) are arranged on the operation panel 10 and, among the plurality of operation devices, a rotation-operation-type operation device that can be rotated up and down by an operator with his/her finger as shown by an arrow Y1 in FIG. 1 is an operation device that is an object of the present invention. Although the rotation-operation-type operation device can also be pushed down in a direction perpendicular to the paper surface of FIG. 1, a description of a configuration for the pushing-down operation will be omitted below. The configuration of the rotation-operation-type operation device will be described in detail below.

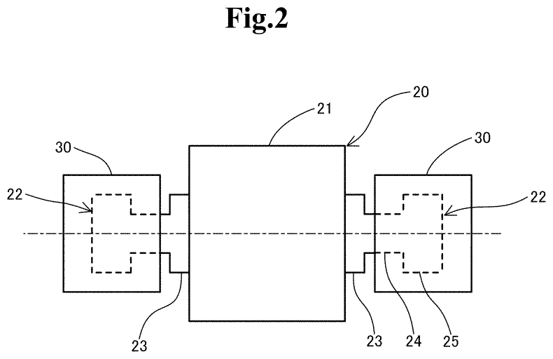

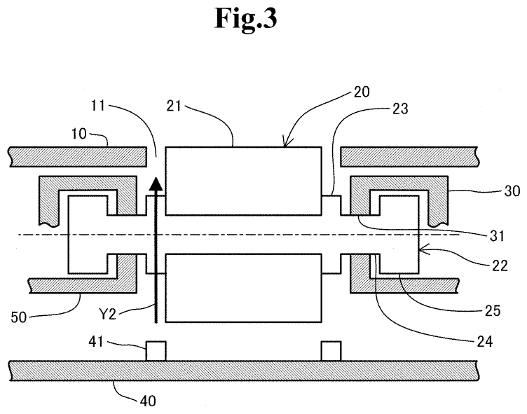

FIG. 2 is a top view showing the configuration of the operation device viewed from above when the operation panel 10 is removed, and FIG. 3 is a cross-sectional view showing the configuration of the operation device including the operation panel 10 when viewed from the side. FIGS. 2 and 3 show the outline of the configuration of the operation device. As shown in FIGS. 2 and 3, the operation device includes a rotation operation unit 20 that is rotatable, a support unit 30 that covers the upper sides of both the ends of the rotation operation unit 20, respectively, and supports the rotation of the rotation operation unit 20, and a second support unit 50 that covers the lower sides of both the ends of the rotation operation unit 20, respectively, and supports the rotation of the rotation operation unit 20 on the lower side. Moreover, as shown in FIG. 3, the operation device includes a board 40 at a position located below the rotation operation unit 20 inside the operation panel 10, and a light source 41 is provided on the board 40. Although FIG. 3 and FIGS. 4 to 6 described later are cross-sectional views of the operation device from the side, hatching is omitted with reference to the rotation operation unit 20 and the light source 41 for convenience of explanation.

As shown in FIG. 3, the rotation operation unit 20 includes a substantially columnar shaft member 22 formed to be a predetermined length extending along the rotation axis direction, and an operation member 21 that has a substantially cylindrical shape and is provided integrally with the shaft member 22 on the outer peripheral side near the center in the rotation axis direction of the shaft member 22. The operation member 21 is formed to have a larger outer diameter than the shaft member 22, and a rotation surface that is the side face of the substantially cylindrical shape is an operation surface to be rotationally operated by the operator. The rotation operation unit 20 is configured so that the shaft member 22 is located inside the operation panel 10, that is, below the operation panel 10, the rotation axis is set substantially parallel to the surface of the operation panel 10, and thereby a site of the rotation surface of the operation member 21 that is located on the upper side, that is, on the operating panel 10 side is exposed to the outside through a substantially rectangular opening 11 formed in the operating panel 10 as shown in FIGS. 1 to 3. With this, the operation surface of the operation member 21 exposed to the outside through the opening 11 of the operation panel 10 can be rotationally operated by the operator.

The shaft member 22 is formed so that its outer diameter differs depending on its position in the axis direction. To be specific, on the side closer to the end than the vicinity of the center of the shaft member 22, an adjacent part 23 (adjacent site), an annular dent 24, and an annular protrusion 25 are formed. The adjacent part 23 is a site adjacent to the operation member 21, the annular dent 24 is located on the side closer to the end than the adjacent part 23 and formed so that its outer diameter is smaller than that of the adjacent part 23, and the annular protrusion 25 is located on the side further closer to the end than the annular dent 24 to form the end of the shaft member 22 itself and formed so that its outer diameter is larger than that of the annular dent 24. Thus, the annular dent 24 is formed so that the rotation surface of the shaft member 22 dents from the adjacent part 23 and the annular protrusion 25 which are adjacent portions adjacent to both the sides in the rotation axis direction. That is to say, the annular dent 24 in which the rotation surface is uniformly formed into a dented shape is formed in a separated site located across the adjacent part 23 along the rotation axis direction away from the operation member 21 provided in the vicinity of the center of the shaft member 22. The outer diameter of the adjacent part 23 and the outer diameter of the annular protrusion 25 may be identical, or may be different.

The shaft member 22 is formed of, for example, a member having a property of transmitting light, such as a transparent resin. With this, the shaft member 22 functions so as to, when the light source 41 placed on the board 40 located below emits light, transmit the emitted light. Then, as shown by an arrow Y2 in FIG. 3, the light from the light source 41 is transmitted through the adjacent part 23 of the shaft member 22 toward the operation panel 10. Since the adjacent part 23 is adjacent to the operation surface formed on the operation member 21 mentioned above, it can be visually recognized by the operator from the outside of the operation panel 10 through the opening 11 at this time. Therefore, the operator can visually recognize the light transmitted through the adjacent part 23 of the shaft member 22 on both the ends in the rotation axis direction with reference to the operation surface of the operation member 21 exposed through the opening 11. Thus, it can be said that the adjacent part 23 of the shaft member 22 is configured to transmit the light from the light source 41 and thereby emit the light.

Further, the annular protrusion 25 located at either of both the ends of the shaft member 22 constitutes, for example, a gear having teeth formed on the rotation surface. Then, to the annular protrusion 25 constituting the gear, a drive mechanism is connected which is located in the operation panel 10 and below the annular protrusion 25 and transmits a rotation force for rotationally driving the shaft member 22 to the annular protrusion 25. For this, grease G is applied to the annular protrusion 25 in order to suppress contact friction with the drive mechanism. The application of the grease G will be described later.

Although the shaft member 22 is configured to transmit light in the above description, it is not necessarily limited to being formed of a member that transmits light. Moreover, although the rotation operation unit 20 is composed of the shaft member 22 and the operation member 21 in the above description, the rotation operation unit 20 may be composed of one integral member.

As shown in FIGS. 2 and 3, the support unit 30 is formed in a substantially bowl shape whose lower side opens so as to cover the upper side of the end of the shaft member 22. Then, as shown in the cross-sectional view of FIG. 3, the support unit 30 is arranged so that an opening end located on a side closer to the center of the shaft member 22 comes into contact with the inner bottom surface of the annular dent 24 of the shaft member 22. Therefore, a site of the support unit 30 that comes into contact with the inner bottom surface of the annular dent 24 forms a sliding part 31 (sliding site) that slides and supports the rotation of the shaft member 22 when the shaft member 22 rotates. Because the sliding part 31 is located on the inner bottom surface of the annular dent 24, the support unit 30 is arranged so as to cover, of the shaft member 22, part of the annular dent 24 located in a position closer to the end along the rotation axis direction than the position of the sliding part 31 and the upper side of the annular protrusion 25.

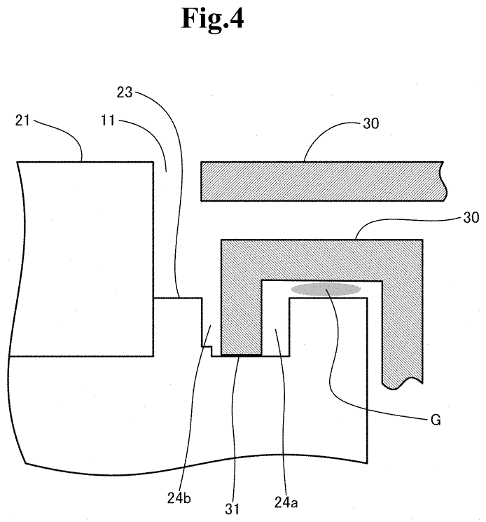

At this time, a portion of the support unit 30 that covers the top of the annular protrusion 25 forms a proximity site that is proximate to the annular protrusion 25. Then, as shown in FIG. 4, the abovementioned grease G is applied to between the annular protrusion 25 and the proximity site of the support unit 30. The grease G is applied when the operation device is assembled.

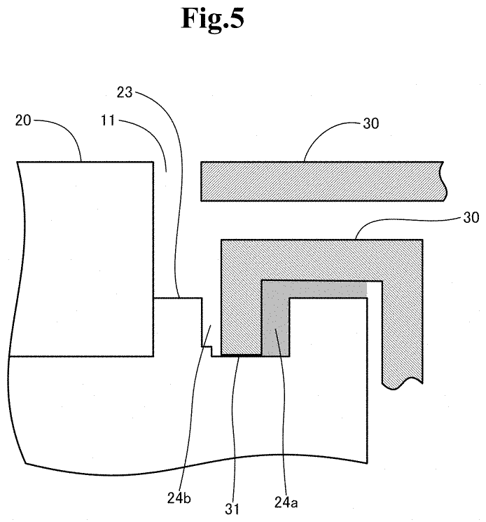

Further, the sliding part 31 of the support unit 30 is arranged so as to be located at a predetermined distance from an inner side surface of the annular dent 24. To be specific, the sliding part 31 is arranged at a predetermined distance from an inner side surface of the annular dent 24 that is on the end side in the rotation axis direction. With this, between the support unit 30 and the shaft member 22, on a side closer to the end in the rotation axis direction than the sliding part 31, a space portion 24a that includes a space inside and above the annular dent 24 and a space between the annular protrusion 25 and the proximity site of the support unit 30 is formed as shown by a gray portion in FIG. 5. The space portion 24a functions as a space that retains the grease G applied to the annular protrusion 25 of the shaft member 22 as described above. At this time, the space portion 24a is formed so as to have a volume larger than the amount of the grease G applied to the annular protrusion 25.

Further, the sliding part 31 of the support unit 30 is arranged at a predetermined distance from the inner side surface of the annular dent 24 on the center side in the rotation axis direction as described above. With this, between the support unit 30 and the shaft member 22, on the side closer to the center in the rotation axis direction than the sliding part 31, a second space portion 24b formed by a space inside the annular dent 24 is formed. The second space portion 24b functions as a space that retains the grease G applied to the annular protrusion 25 of the shaft member 22 as described above. That is to say, the grease G applied to the annular protrusion 25 remains in the abovementioned space portion 24a and also enters between the inner bottom surface of the annular dent 24 and the sliding part 31 of the support unit 30, and the grease G may further enter the second space portion 24b, but remains in the second space portion 24b. At this time, the second space portion 24b is formed to have a size that does not cause the capillary action of the grease G. Consequently, even if the grease G enters the second space portion 24b, the capillary action does not occur in the second space portion 24b, so that the grease G does not move upward in the second space portion 24b and is prevented from reaching the adjacent part 23. In particular, it is possible to effectively prevent oil removed from the grease from reaching the adjacent part 23 due to the capillary action. As an example, as the size of the second space portion 24b that does not cause the capillary action in the grease G, a distance between the inner side surface of the annular dent 24 closer to the center in the rotation axis direction and the surface of the support unit 30 facing the inner side surface is set to be longer than 0.3 mm. However, such a size of the second space portion 24b is an example, and may be any size.

Thus, in the rotation-operation-type operation device according to the present invention, the space portion 24a in which the grease G applied to the shaft member 22 remains is formed in a position closer to the end in the rotation axis direction than the position of the sliding part 31 of the support unit 30 that slides and supports the rotation of the shaft member 22. Therefore, it is possible to prevent the grease G from moving toward the center of the shaft member 22, specifically, moving up to the adjacent part 23 of the shaft member 22 adjacent to the operation member 21 on which the operation surface is formed, and prevent the grease G from adhering to the surface of the adjacent part 23. As a result, in a case where the adjacent part 23 is configured to emit light and the light-emitting surface can be visually recognized through the opening 11 of the operation panel 10 as in this example embodiment, it is possible to suppress adhesion of the grease to the light-emitting surface and suppress decrease of the brightness of the light-emitting surface, and it is possible to suppress deterioration of the design of the operation device itself. In a case where the adjacent part 23 is not configured to emit light, the adjacent part 23 is also in a position where it can be visually recognized through the opening 11 of the operation panel 10, so that it is possible to suppress adhesion of the grease G to the surface of the adjacent part 23, and it is possible to suppress deterioration of the designs of the operation device itself and equipment provided with the operation device.

Further, in the above operation device, the second space portion 24b in which the grease G remains is also formed on the side closer to the center in the rotation axis direction than the sliding part 31 of the support unit 30 that slides and supports the rotation of the shaft member 22. Therefore, it is possible to further prevent the grease G from moving up to the adjacent part 23 of the shaft member 22, and it is possible to more effectively prevent the grease G from adhering to the surface of the adjacent part 23. As a result, it is possible to suppress deterioration of the designs of the operation device itself and equipment provided with the operation device.

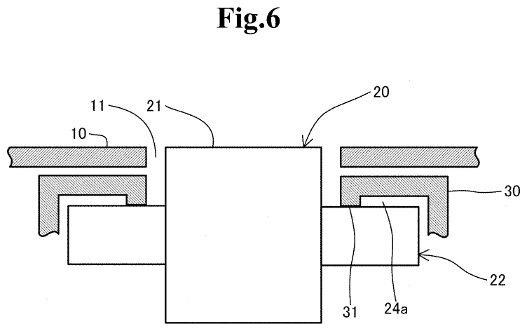

Although the annular dent 24 is formed on the end side of the shaft member 22 and the space portion 24a retaining the grease G is formed using part of the annular dent 24 in the above description, it is not necessarily required to provide the shaft member 22 with the annular dent 24. For example, as shown in FIG. 6, without providing the shaft member 22 with the annular dent 24, it is possible to configure so that the sliding part 31 of the support unit 30 comes into contact with any position on the rotation surface of the shaft member 22 separated from the operation surface of the operation member 21 toward the end in the rotation axis direction. With this, the space portion 24a formed between the support unit 30 and the shaft member 22 in a position further closer to the end of the shaft member 22 than the position of the sliding part 31 may be used as a space that retains the grease G.

Further, by forming the space portion 24a closer to the end of the shaft member 22 than the sliding part 31 as mentioned above, the grease G may be prevented from entering the sliding part 31. Therefore, the abovementioned second space portion 24b between the adjacent part 23 of the shaft member 22 adjacent to the operation surface of the operation member 21 and the sliding part 31 of the support unit 30 may be omitted.

Although it has been described above that the rotation-operation-type operation device according to the present invention is mounted on the steering of an automobile, the operation device is not limited to an operation device mounted on the steering of an automobile, but may be applied to an operation device mounted in another position of an automobile. The operation device can also be applied to an operation device mounted on any device without being limited to an automobile. Moreover, a case where the rotation-operation-type operation device according to the present invention is one of a plurality of operation devices arranged on the operation panel 10 has been illustrated above, but the operation device may be configured as a single operation device.

### <Supplementary Notes>

The whole or part of the example embodiments disclosed above can be described as the following supplementary notes. Below, the outline of an operation device according to the present invention will be described. However, the present invention is not limited to the following configurations.

### (Supplementary Note 1)

An operation device comprising:

a rotation operation unit that is rotatable about a rotation axis, the rotation operation unit being installed so that an operation site formed on a rotation surface is exposed outside through an opening formed in an operation panel; and

a support unit covering at least part of a separated site of the rotation operation unit located away from the operation site along a rotation axis direction, the support unit having a sliding site that comes into contact with part of the separated site and slidably supports rotation of the rotation operation unit,

wherein the support unit is configured to form a space part retaining grease applied to the rotation operation unit, the space part being formed between the support unit and the separated site located on a side opposite to the operation site of the rotation operation unit with reference to the sliding site.

### (Supplementary Note 2)

The operation device according to Supplementary Note 1, wherein:

the rotation operation unit has an annular dent formed on the rotation surface located in the separated site; and

the support unit is configured so that the sliding site is located on an inner bottom surface of the annular dent and the sliding site is located at a predetermined distance from an inner side surface of the annular dent.

### (Supplementary Note 3)

The operation device according to Supplementary Note 2,

wherein the rotation operation unit is configured so that an adjacent site located between the operation site and the annular dent and adjacent to the operation site can be visually recognized from outside the operation panel through the opening.

### (Supplementary Note 4)

The operation device according to Supplementary Note 3,

wherein the adjacent site of the rotation operation unit is configured to emit light.

### (Supplementary Note 5)

The operation device according to Supplementary Note 3 or 4, wherein:

the rotation operation unit has an annular protrusion to which the grease is applied, the annular protrusion being formed, on the rotation surface of the separated site, at an adjacent portion adjacent to the annular dent on the side opposite to the operation site; and

the support unit has a proximate site covering the annular protrusion in proximity to the annular protrusion.

### (Supplementary Note 6)

The operation device according to Supplementary Note 5, wherein:

the space part is formed including a space inside and above the annular dent located on the side opposite to the operation site of the rotation operation unit with reference to the sliding site of the support unit and a space between the annular protrusion of the rotation operation unit and the proximity site of the support unit.

### (Supplementary Note 7)

The operation device according to any of Supplementary Notes 1 to 6, wherein the space part is formed to be larger than an amount of the grease applied to the rotation operation unit.

### (Supplementary Note 8)

The operation device according to any of Supplementary Notes 2 to 7, wherein the rotation operation unit has a second space part retaining the grease, the second space part being formed in an inner space of the annular dent located on a side closer to the operation site with reference to the sliding site of the support unit.

### (Supplementary Note 9)

The operation device according to Supplementary Note 8, wherein the second space part is formed in a size that does not cause capillary action of the grease.

Although the present invention has been described above with reference to the example embodiment and the like, the present invention is not limited to the above example embodiment. The configurations and details of the present invention can be changed in various manners that can be understood by one skilled in the art within the scope of the present invention.

### DESCRIPTION OF REFERENCE NUMERALS

10 operation panel
11 opening
20 rotation operation unit
21 operation member
22 shaft member
23 adjacent part
24 annular dent
24a space portion
24b second space portion
25 annular protrusion
30 support unit
31 sliding part
40 board
41 light source
50 second support unit

1. An operation device comprising:
a rotation operation unit that is rotatable about a rotation axis, the rotation operation unit being installed so that an operation site formed on a rotation surface is exposed outside through an opening formed in an operation panel; and
a support unit covering at least part of a separated site of the rotation operation unit located away from the operation site along a rotation axis direction, the support unit having a sliding site that comes into contact with part of the separated site and slidably supports rotation of the rotation operation unit,
wherein the support unit is configured to form a space part retaining grease applied to the rotation operation unit, the space part being formed between the support unit and the separated site located on a side opposite to the operation site of the rotation operation unit with reference to the sliding site.

2. The operation device according to claim 1, wherein:
the rotation operation unit has an annular dent formed on the rotation surface located in the separated site; and
the support unit is configured so that the sliding site is located on an inner bottom surface of the annular dent and the sliding site is located at a predetermined distance from an inner side surface of the annular dent.

3. The operation device according to claim 2,
wherein the rotation operation unit is configured so that an adjacent site located between the operation site and the annular dent and adjacent to the operation site can be visually recognized from outside the operation panel through the opening.

4. The operation device according to claim 3,
wherein the adjacent site of the rotation operation unit is configured to emit light.

5. The operation device according to claim 3, wherein:
the rotation operation unit has an annular protrusion to which the grease is applied, the annular protrusion being formed, on the rotation surface of the separated site, at an adjacent portion adjacent to the annular dent on the side opposite to the operation site; and
the support unit has a proximate site covering the annular protrusion in proximity to the annular protrusion.

6. The operation device according to claim 5, wherein:
the space part is formed including a space inside and above the annular dent located on the side opposite to the operation site of the rotation operation unit with reference to the sliding site of the support unit and a space between the annular protrusion of the rotation operation unit and the proximity site of the support unit.

7. The operation device according to claim 6, wherein the space part is formed to be larger than an amount of the grease applied to the rotation operation unit.

8. The operation device according to claim 2, wherein the rotation operation unit has a second space part retaining the grease, the second space part being formed in an inner space of the annular dent located on a side closer to the operation site with reference to the sliding site of the support unit.

9. The operation device according to claim 8, wherein the second space part is formed in a size that does not cause capillary action of the grease.
